(19) United States
(12) Patent Application Publication
(10) Pub. No.: US 2016/0125296 A1
(43) Pub. Date: May 5, 2016

(54) System and Method for Securing an Architectural Environment Against Crime and Minimizing Criminal Elements

(71) Applicant: SAFE DESIGN TECHNOLOGIES INC., Victoria (CA)

(72) Inventors: Nikki Filipuzzi, Calgary (CA); Kelly Sundberg, Calgary (CA); Tanya Trussler, Calgary (CA)

(21) Appl. No.: 14/894,440

(22) PCT Filed: May 28, 2014
(86) PCT No.: PCT/CA2014/050499

§ 371 Date: Nov. 27, 2015

Related U.S. Application Data
(60) Provisional application No. 61/828,151, filed on May 28, 2013.

(51) Int. Cl. G06N 5/04; G06F 17/50

(52) U.S. Cl. CPC G06N 5/04; G06F 17/5004

(57) ABSTRACT

A computer-implemented method is provided for analysing and designing a physical environment for discouraging criminal activity within the physical environment. The physical environment is assessed and risk factors are identified that make the physical environment vulnerable to criminal activity. In one embodiment, risks posed by the nature and location of the physical environment within a spatial footprint are calculated. Further, the physical environment is evaluated to identify physical elements of the environment that could make the structure vulnerable to criminal attacks. Risk scores assigned to all of these factors are then analyzed to generate a recommendation report for at least one of the physical elements. Deploying at least one of the recommendations in the report aids in improving a deterrent rating assigned to that physical element and subsequently integrity of the physical environment against criminal attacks.

### FIELD

Embodiments described herein relate to a system and method for improving safety and security of a physical environment while retaining architectural and landscape features.

### BACKGROUND

Since 1829, when French researchers Adriano Balbi and André Michel Guerry first began using maps to plot criminal events, police and criminologists have increasingly explored the relationship between crime and geography. Despite over a century of crime mapping, it has only been in the latter part of the 20th century when computer-based technologies evolved to allow researchers the ability to better understand how crime can be identified, analyzed, mapped and ultimately prevented through the engineering of urban environments.

In 1971, Dr. C. Ray Jeffery introduced the concept of Crime Prevention Through Environmental Design (CPTED). CPTED is a multi-disciplinary approach for preventing crime through the engineering of environments. CPTED is based on the notion that the behavior of potential offenders can be influenced through an altering of physical spaces. Characteristically, CPTED is only applied to already constructed urban environments and often results in the addition of obtrusive physical security features being used to control access to a property. CPTED generally focuses on deterring offenders from committing offences in specific spaces and risks displacing, rather than preventing, criminal activity. Despite criticisms, CPTED has been proven to be a valuable and informed means of preventing crime within urban settings, and has helped many neighborhoods realize reduced incidents of crime.

Another set of principles commonly used to deter crime through architectural design is based on the concept of Prevention Through Urban Design (CPTUD) introduced by architect Oscar Newman in his 1972 book titled “Defensible Space: Crime Prevention through Urban Design”.

Key considerations for both CPTED and CPTUD are natural surveillance, natural access control, territorial reinforcement and maintenance. It is believed that application of these key considerations to a geographical space can help deter crime in the geographical space.

Definitions of the key considerations can be found in several publications and articles discussing the CPTED and CPTUD concepts. Access control is generally defined in “Crime Prevention Through Environmental Design (CPTED) and The New South Wales Crime Risk Assessment Guidelines: A Critical Review. Crime Prevention and Community Safety”, pages 1-15 by G. Clancey, M. Lee, and D. Fisher as being the manner by which vehicle and pedestrian traffic enters, moves through, and exits a defined geographic space. Surveillance as described in “Environmental Criminology: Evolution, Theory, and Practice”, New York, N.Y.: Routledge, pages 104 and 105 by M. A. Andersen is generally accepted as being achieved when lawful users and guardians are able to observe the activities of a potential offender within a geographical space either naturally or with the aid of a technology. Andersen also categorizes territorial reinforcement (or territoriality) as being the creation of an environment whereby public and private space are well defined, and where structures and landscapes are organically interrelated. Space management is defined in “Crime Prevention Through Environmental Design: Applications of Architectural Design and Space Management Concepts”, 2^{nd} Edition dated 2000 by T. D. Crowe as the way an environment is physically maintained, how usage of the site is organized and programmed, and ultimately what rules or guidelines are implemented to ensure a desired social and physical norm.

However, there is no organization or program that gives a standardized definition of the key considerations discussed above or a systematic process that can be logically applied to a geographical space to secure the geographical space against crime.

Further, both CPTED and CPTUD strategies do not quantify the consideration of how socio-economic, geographic, criminogenic and demographic features of a geographical space interact, limiting the analysis of how these features may influence behavior of a motivated offender within the geographical space. In addition, neither CPTED nor CPTUD identifies weighted risk factors associated with the nature/function of the geographical space.

Therefore, there is a need for a novel standardized procedure for reliably and reproducibly implementing the CPTED and CPTUD concepts.

### SUMMARY

According to one broad aspect, a standardized procedure based on the CPTED and CPTUD key considerations is disclosed, which when applied to a physical environment, new or existing, will deter a potential or motivated offender from entering the environment or acting within the environment, thereby reducing criminal activity in and about the environment.

The technique/method is defined herein as a Security Achieved Through Functional Environmental (SAFE) Design Standard or SAFE Design Standard™.

The method disclosed herein includes the progressive examination of crime risks stemming from a multitude of factors associated with the social and physical environment, and generates a mitigation plan or recommendation report based on these identified risks. The mitigation plan generally contains a recommendation to modify one or more of the architectural and landscape features of the physical environment which when deployed makes the environment safe and secures it against crime. In other words, the recommendation when deployed deters or discourages an individual disposed to commission of a crime within the physical environment. The method disclosed herein is a systematic approach to deterring or preventing crime through informed design and engineering.

The method is applicable to a wide range of physical environments including governmental, educational, residential, commercial, industrial or historical. The method can be applied to new or existing properties.

Accordingly in one broad aspect a computer-implemented method of analysing and designing a physical environment for discouraging criminal activity within the physical environment is provided. The method comprises calculating a first risk score based on classification of the physical environment within a pre-determined category. A second risk score based on the geographical location of the physical environment. The method also calculates a third risk score based on review of management and security policies of the physical environment. Further, a fourth risk score is calculated by extracting from the physical environment's three dimensional data, attributes of pre-determined physical elements which contribute to the structural layout and working of the physical environment. A deterrent rating is assigned to each of the physical elements based on divergence or adherence of the extracted attributes to threshold attributes for the physical elements. The fourth risk score is calculated based on the assigned deterrent ratings. The final step of the method comprises generating a recommendation report for at least one of the physical elements for improving the deterrent rating assigned to at least one physical element. The recommendation report is generated based on the first risk score, the second risk score, the third risk score and the fourth risk score.

Accordingly in another broad aspect a computer based system for analysing and designing a physical environment for deterring a motivated offender from committing a crime within the physical environment is provided. The system comprises a memory and a processing structure coupled to the memory and executing computer-readable code. The code comprises a step of calculating a first risk score based on classification of the physical environment within a pre-determined category. Further, the code calculates a second risk score based on the geographical location of the physical environment. The code also calculates a third risk score based on review of management and security policies of the physical environment. A fourth risk score for the physical environment is also calculated based on a deterrent rating assigned to at least one physical element of the physical environment. Finally, the code generates a recommendation report for the at least one physical element for improving the deterrent rating assigned to the at least one physical element. The recommendation report is generated based on the first risk score, the second risk score, the third risk score and the fourth risk score.

Accordingly in another broad aspect a non-transitory computer-readable storage medium comprising computer-executable instructions for analysing and designing a physical environment for deterring a motivated offender from committing a crime within the physical environment is provided. The machine-readable instructions, when executed, cause a processor to perform a series of process steps. A first process step comprises calculating a first risk score based on classification of the physical environment within a pre-determined category. The process comprises calculating a second risk score based on the geographical location of the physical environment. Further, a third risk score is calculated based on review of management and security policies of the physical environment. Lastly, a fourth risk score is calculated based on a deterrent rating assigned to at least one physical element of the physical environment. The process culminates in generation of a recommendation report for the at least one physical element for improving the deterrent rating assigned to the at least one physical element. The recommendation report is generated based on the first risk score, the second risk score, the third risk score and the fourth risk score.

### BRIEF DESCRIPTION OF THE DRAWINGS

FIG. 1 is a schematic diagram illustrating a computer system for securing a physical environment against crime according to one embodiment;

FIG. 2 is a schematic diagram illustrating the physical components of the system of FIG. 1;

FIG. 3 is a schematic diagram illustrating the functional components of the system of FIG. 1;

FIG. 4 is a high level flowchart illustrating steps performed by the system of FIG. 1;

FIG. 5 illustrates an example of a survey or audit template identifying pre-determined physical elements, contributing to the interior layout and working of the physical environment, and considered for securing the physical environment against crime;

FIG. 6 illustrates an example of a survey or audit template identifying pre-determined physical elements, contributing to the exterior layout and working of the physical environment, and considered for securing the physical environment against crime;

FIG. 7 is an example of a detailed flowchart illustrating steps performed by the system of FIG. 1; and

FIGS. 8A to 8F are screenshots of an exemplary embodiment of an interactive unit/device of the system, wherein the unit displays questions for calculating at least one individual risk score and an overall risk score for the physical environment.

### DETAILED DESCRIPTION

The method and system described below can be used to secure a wide range of physical environments against crime. As used herein, the term “physical environment” is broadly construed to mean one or more buildings, structures, locations and/or areas having vehicular and/or human ingress and egress. Non-limiting examples include schools, supermarkets, restaurants and hospitals.

As used herein, the term “secure a physical environment” is broadly construed to mean making a physical environment, which is pre-existing, safe by rehabilitating its physical elements or features thereby deterring or preventing an offender from committing a criminal activity therein as opposed to introducing new physical elements such as barriers in the form of walls or moats around or within the physical environment. In other words, the method described herein uses the existing physical elements of a pre-existing physical environment to make it secure and safe and does not modify the structure and layout (architecture) of the physical environment. Non-limiting examples of physical elements include signage, surveillance schemes, lighting system and landscaping.

The method described herein evaluates or assesses the physical environment and identifies risk factors stemming from vulnerabilities in and around the physical environment. These risk factors are collectively analyzed to create/generate a recommendation that may result in modification of at least one physical element within or around the physical environment. Such physical element typically contributes to the structural layout and working of the physical environment. Modification of the physical element increases visibility or detectability of a motivated offender within and about the physical environment and deters the motivated offender from committing a crime within the physical environment. The physical environment, when modified, encourages a motivated offender to reconsider his decision or contemplation to commit a crime within the physical environment.

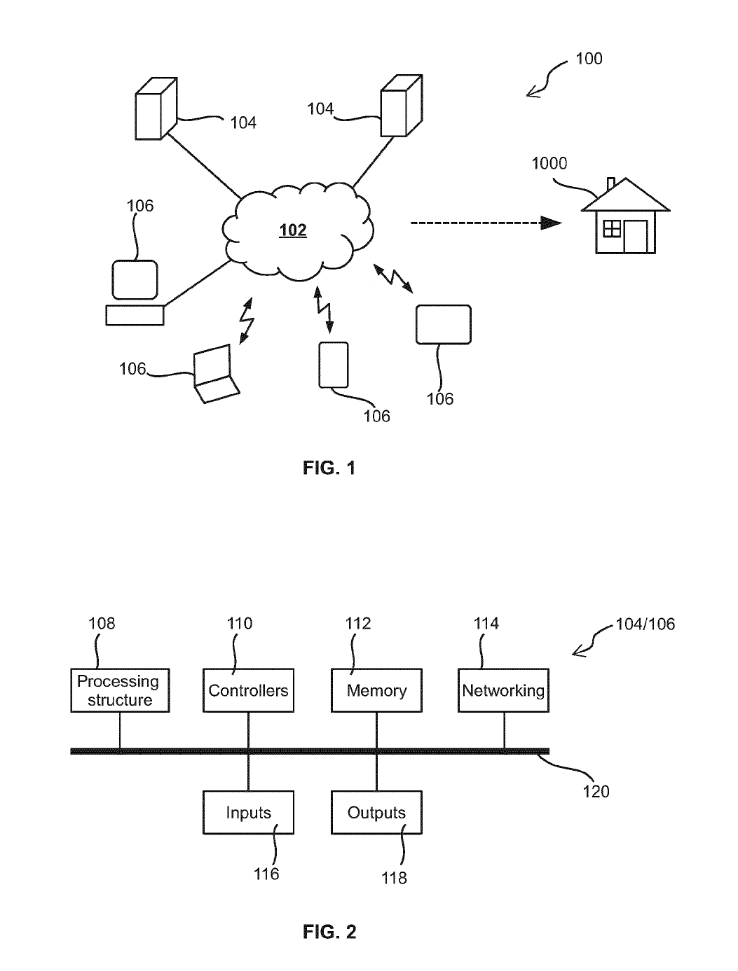

FIGS. 1 and 2 illustrate the physical and functional components of a computerized system 100 which enables identification of risks associated with a physical environment and which risk factors, if not mitigated, could render the physical environment vulnerable to criminal activity.

The computer system 100 identifies crime risks associated with the physical environment 1000 from a multitude of factors and generates a recommendation report which when deployed secures the physical environment 1000 against crime. The recommendation report is based on risk scores calculated and or assigned to the factors contributing or responsible for making the physical environment vulnerable to criminal attacks. Generally these factors are physical and/or functional elements contributing to the location, structural layout and working of the physical environment.

In detail, and with reference to FIG. 1, the computer system 100 comprises a computer network 102 functionally connecting to a plurality of computing devices 104 and 106. The computing devices 104 and 106 include one or more computer servers 104, and a plurality of client computing devices or interactive units 106 such as tablets, smartphones, desktop computers, laptop computers, PDAs and the like. Here, the computer network 102 is a network for connecting computing devices, and may be a local area network (LAN), wide area network (WAN), metropolitan network (MAN), Internet, 4G wireless communication network or the like. As those skilled in the art will appreciate, computer servers 104 and client computing devices 106 may connect to the network 102 via wired or wireless means, e.g., Ethernet, WiFi®, Bluetooth®, Zigbee®, or the like.

It should be appreciated that the representative environment depicted in FIG. 1 may be implemented on a single computing device on which various functional components reside.

The client computing devices 106 may be used to input data and collaborate with the one or more computer servers 104 for generating recommendations which, when implemented, would secure the physical environment against crime.

FIG. 2 illustrates physical components of the computer server 104 or the client computing device 106. As shown, the computer server 104 or the client computing device 106 comprises a processing structure 108, one or more controllers 110, memory or storage 112, a networking module 114, inputs 116 and outputs 118, all functionally interconnected by a system bus 120. The processing structure 108 may be one or more single-core or multiple-core computing processors such as Intel® microprocessors offered by Intel Corporation of Santa Clara, Calif., USA, AMD® microprocessors offered by Advanced Micro Devices of Sunnyvale, Calif., USA, ARM® microprocessors manufactured by a variety of manufactures under the ARM® architecture developed by ARM Ltd. of Cambridge, UK, or the like. The controllers 110 may be graphic controllers, input/output chipsets and the like, for coordinating operations of various hardware components and modules of the computing device.

The client computing, data collecting or input devices 106 communicate with the server computer 104 and are part of a data collection system, being a convenient and typical interface for the collection and input of characteristics of specified elements related to the physical environment of interest. The element characteristics are stored in an element database. In a usual situation, devices 106 are implemented both the location of the element to be monitored and at a management location.

Various responsible parties interact with the system 100 for providing inputs and accessing outputs therefrom. The system not only includes the element database, but also a rule application system comprising a rule application program for implementing rules selected from a rule database. The rules in the rule database include those prescribed by standards, both regulatory and those taught by experience including know-how, industry standard rules, as well as an entity's or auditor's own rules such as those concerning those operations where it deems operation should be conducted in a manner that exceeds the minimum requirements or in situations where there have previously not been any minimum requirements. An element database contains one or elements, each element having characteristics having a quantifiable state (characteristic data), at least some of the characteristics being associated with standards or rules, the quantifiable state including logical values, yes/no values, and numerical values. The rule database is associated with at least one of the one or more characteristic data for the elements. It is clear to those of skill in the art that the data in the element and rule databases could be combined and managed in one or a plurality of databases.

A database program that is suitable for containing all of the element and rule data is the open-source PostgreSQL database program that allows for multiple tables of data in one large database. PostgreSQL is an Object-Relational DBMS, supporting almost all SQL constructs, including subselects, transactions, and user-defined types and functions. Other commercial database programs have similar functionality and include the Oracle™ database program from Oracle Corporation, Redwood Shores, Calif., USA.

It is understood that the data collection devices 106 can also operate some of the application programs and maintain a database system similar to that described above for the server computer 104. Such application programs can manage the rule database for application in cooperation with the element database to determine which characteristics of the physical environment are relevant and for weighting or ratings associated therewith for assessing the probability of an adverse event such as criminal activity.

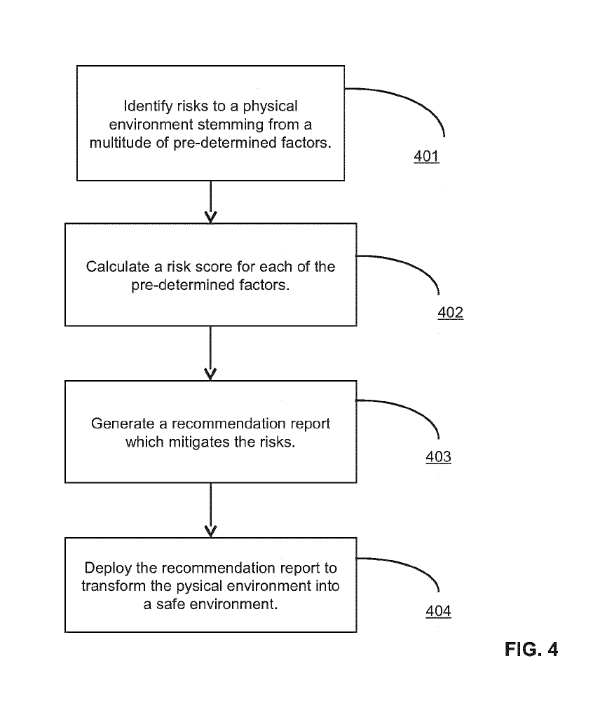

FIG. 4 gives an overview of the steps involved in securing the physical environment 1000 against criminal activity. The process starts, at block 401, by analyzing the physical environment 1000 and its surroundings to identify vulnerable structural and functional elements that could compromise deterrents and motivate an offender to commit a crime within the physical environment 1000. At block 402, a risk score is assigned to each of these structural and functional elements. At blocks 403 and 404, the assigned risk scores are then analyzed to generate a recommendation report outlining steps to mitigate the risks. This typically involves modification of one or more of the considered physical and functional elements. Appropriate modification of the one or more elements is directed to increase the safety of the physical environment 1000.

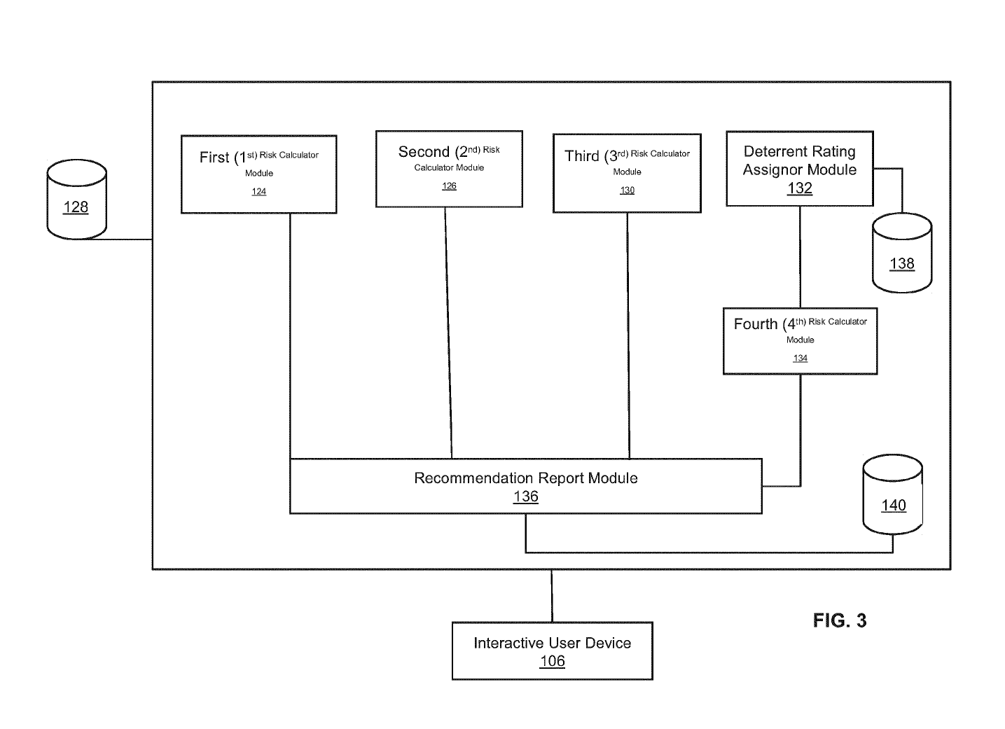

FIG. 3 shows the functional components of the system 100. The system 100 comprises a first risk calculator module 124 that assigns a first risk score to the physical environment based on the nature of the physical environment. Different physical environments may have different criminogenic risks. For example, risk factors for a hospital may not be the same as the risk factors for a supermarket or a school. The first risk score is determined by the combination of the probability of an adverse event (such as crime) occurring in the physical environment, the vulnerability of the physical environment, and the exposure of the physical environment.

The first risk score is calculated as follows:

R=(P+V+E)/3

where

R is the probability of a harmful outcome such as crime,

P is the probability or the likelihood of an adverse event such as crime occurring within the physical environment,

V is the vulnerability of the physical environment to such an adverse event (the potential for loss), and

E is the exposure (the size and characteristics of the at risk population within and about the physical environment).

The system further comprises a second risk calculator module 126 that assigns a second risk score to the physical environment 1000. The principle behind this risk score is that a physical environment is not isolated from its surroundings, and factors stemming from its surroundings, although external to the physical environment 1000, can contribute to risks associated therewith. For example, a physical environment, regardless of its type or nature, exists within a community (level 1), then within a city or rural area (level 2), then within a region, state or province (level 3), and then within a country (level 4). Each level has its own associated risk factors. In one embodiment, measurable indicators from all four levels are analyzed by the second risk calculator module 126 before assigning the second risk score.

At a higher level, and in one embodiment, the second risk calculator module 126 receives historical crime data linked to the geographical location of the physical environment from a database 128. A person of skill in the art would understand that such a database is typically maintained by a national, federal, provincial or municipal policing body. The second risk calculator module 126 also receives data from a pre-defined perimeter of the physical environment, in the form of collaborating indicators, contributing to or substantiating the retrieved crime data. It is understood that the database 128 can also include other elements of the physical environment including historical data, factors,

Examples of collaborating indicators may be, but are not limited to, graffiti writing, broken windows, and pavement and road that are not maintained. The collaborating indicators may be identified by conducting a survey of the physical environment and its surroundings by personnel and responding to a set of pre-determined questions. In one embodiment, the questions may be displayed on the interactive unit 106 of the system 100 and may be drawn from a database cooperating with the system 100. Examples of questions may include “Is there graffiti?” If input received is yes, then one determines further factors through additional questions in a hierarchy of questions including Is the graffiti an isolated instance or is prevalent?“, Can the graffiti be classified as art or tagging?”, and if tagging “Is it gang-related or undisclosed”. Responses received impact the risk score. The crime data and the collaborating indicators are analyzed by the second risk calculator module 126 and a second risk score is calculated based on this analysis.

Other factors that may be used for calculating the second risk score may be measurable indicators derived from, for example, federal legislation surrounding firearms, the Gini coefficient developed by Corrado Gini and published in his 1912 paper titled “Variability and Mutability”, population density, employment rates, poverty rates, and policing policies around the geographical location of the physical environment.

The system 100 further comprises a third risk calculator module 130 that assigns a third risk score to the physical environment 1000 based on review of maintenance and security policies of the physical environment. Most physical environments have maintenance policies that are typically geared towards upkeep of the structural and functional elements within and about the physical environment.

A typical maintenance policy would include periodic review of physical and functional elements of a physical environment. In broad terms, a maintenance policy checks for any visible deterioration of the physical environment such as presence of broken windows, overgrowth of vegetation in or around the physical environment, non-optimal working of lighting within and about the physical environment. Example of a maintenance policy is as follows:

### EXAMPLE

1. Are major spaces, circulation routes, signage, surfaces and furnishings located throughout the physical environment clean and well maintained?

2. Is there defacement or destruction of property?If so are steps being taken to repair it?

3. Is there visible damage to any structures, surfaces, furnishings, programmed spaces or circulation routes?

4. Are there full or overflowing garbage cans, litter in recesses or unclean windows, walls or floors?

5. Is signage within the physical environment chipped or faded?

6. Are walls and/or furnishings torn, scratched, worn out or in need of repair?

7. Is there browning, dead, or damaged vegetation within the physical environment?

8. Is vegetation well trimmed and planter boxes in good condition?

9. Is there any litter in planter boxes?

10. Are light fixtures well maintained and in good working order with no burnt out light bulbs?

As is well accepted, maintenance gives the illusion of occupancy and therefore aids in deterring a motivated offender from committing a crime. Therefore, a physical environment having a well-balanced maintenance policy would result in a low risk score whereas a physical environment having a poor maintenance policy would result in a high risk score.

The system 100 further comprises a deterrent rating factor assignor module 132, which assigns a deterrent rating to at least one physical element contributing to the structural layout and working of the physical environment. The deterrent rating assigned to a physical element is on the basis of adherence or divergence of an attribute of that physical element from a pre-determined threshold attribute for that physical element. The physical element may be a structure enabling/governing ingress and egress from the physical environment, enabling navigation of traffic within physical environment, enabling visibility of traffic within and about the physical environment. In one embodiment, the physical elements comprise elements governing at least one entry and at least one exit to the physical environment, vehicular and/or human traffic about and within the physical environment, landscaping surrounding the physical environment, illumination profile about and within the physical environment, and signage about and within the physical environment. In other words, an audit of the physical environment is conducted.

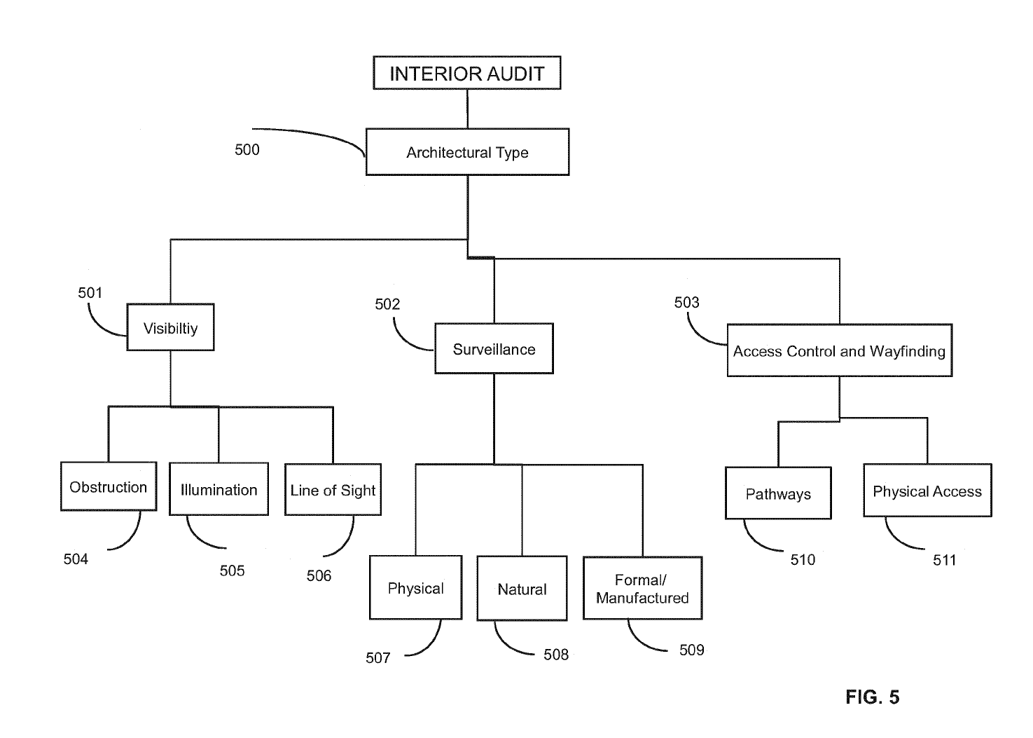

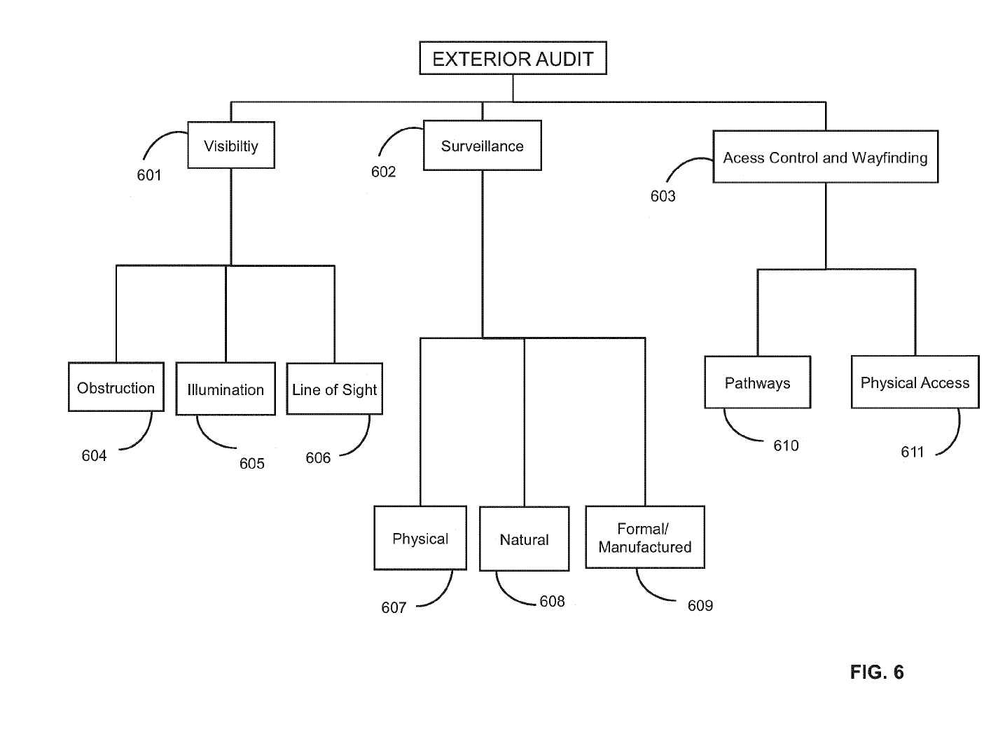

The audit can be implemented in various ways. In one embodiment, and as seen in FIGS. 5 and 6, an interior audit and an exterior audit are carried out. During the interior audit and with reference to FIG. 5, the physical environment is first categorized as one of a set of pre-determined categories. In the example illustrated in FIG. 5, the physical environment is a restaurant 500. During the interior audit, attributes of physical elements located within the restaurant are extracted, which include elements contributing to visibility 501, security and surveillance 502 and wayfinding and access control 503. Sub-categories of visibility include obstructions 504, illumination 505 and line of sight 506. Sub-categories of surveillance include various forms of surveillance such as physical surveillance 507, natural surveillance 508 and manufactured or formal surveillance 509. Access and wayfinding can be broken down to movements and pathways 510 and physical access 511.

As is well accepted, visibility 501 and natural surveillance block 508 refer to the ability to see what is occurring within the physical environment. It is an accepted architectural principle that if a physical environment is properly designed, passive observation of the elements within the physical environment will be facilitated. Visibility constitutes the visual field that can be achieved through lines of sight. Natural surveillance refers to the placement of physical features within a physical space to maximize the observation of social interactions within the space. Natural surveillance involves designing windows, lighting and landscape to improve the ability to observe what is going on in and around a site and its buildings. Through design, natural surveillance and visibility can be maximized resulting in a site becoming a less attractive target; an increase in criminal detection; and, legitimate users feeling safer within the environment. Visibility and natural surveillance help to maximize the number of eyes watching over a space. As people move in and around the space, they will be able to naturally observe social interactions and activities. When visibility and natural surveillance are at optimum levels, the perception that one can be seen increases, and opportunities for crime become more limited. In essence, potential offenders will become uncomfortable within a space where they feel exposed and easily identified. Natural surveillance must promote keeping potential offenders under observation and make them feel exposed and less likely to commit a criminal act and cause legitimate users to feel safe as a result of their being easily seen by others.

Physical and manufactured surveillance 507 and 509 refer to any manmade features that oversee, prevent or control movement within the physical environment. Manufactured surveillance includes active surveillance and systems utilized to prevent and detect crime. Manufactured surveillance deters potential intruders with signage and markings, distinguishes authorized from unauthorized individuals, detects and prevents intrusion attempts, and triggers appropriate incident responses. Physical surveillance includes personnel overseeing the physical environment. Formal surveillance includes access controls which can take the form of gates, fences, locks, alarms and all vehicular and pedestrian controls; closed circuit TV (CCTV) surveillance; emergency communications such as help phones and panic buttons.

Access control and wayfinding 503 are central to environmental crime prevention. As is well accepted, access is a means of entering or exiting a space. Access control is a selective restriction of access to a space. Wayfinding encompasses all of the methods by which individuals orient themselves in a physical space and navigate from one area to another within the physical space. Wayfinding reflects to an individual's experience of orientation and route selection within a physical environment. Wayfinding also includes tools such as signage that aid in orientation and route selection/navigation. Both wayfinding and access control makes use of signage and a physical environment's spatial attributes to control movement and flow within and about the physical environment. Signage is commonly used to enhance wayfinding efficiency and to control movement. It is also used to denote areas that are to remain closed to visiting users.

Referring back to FIG. 5, the deterrent rating assignor module 132 assigns a deterrent rating to a physical element based on inputs received regarding attributes of the physical element. In one embodiment, the attributes are extracted from the physical environment's three-dimensional data. The extraction process, in one embodiment, may include review of a design plan of the physical environment or survey of the physical environment by a personnel.

In one embodiment, the attributes are determined by displaying a set of questions to the personnel conducting the survey on the interactive unit 106 of the system 100. The deterrent rating assignor module 132 obtains the questions from a populated database, a data warehouse or other storage device 138 collaborating with the system 100. In one embodiment, an institution providing the methodology described herein populates the database 138 with the questions. Example of a set of questions that aid in determining attributes of the physical elements considered during the interior audit is as follows:

### Example

### Visibilty

Does sufficient visibility exist when looking inwards from the building entrance towards the building lobby or public circulation area?

How would you rate the level of visibility between the reception/security desk and the building entrance?

Is there sufficient visibility within the lobby area?

Are there opportunities for entrapment within the lobby area?

Is the external entrance area visible from within the internal building entrance?

Does the lobby design and layout of the lobby furnishings encourage natural surveillance?

Is the lighting in the internal building entrance at the appropriate level?

Is the lighting in the entrance lobby at the appropriate level?

Is the lighting at the reception desk at the appropriate level?

Is the lighting between 30-75LUX within the building entries and lobbies?

Is the lighting between 30-100LUX within the internal gathering spaces?

Is the lighting between 20-100LUX within the internal circulation routes?

### Surveillance

Is there evidence of a physical security presence in the building entrance and lobby?

Is the placement of panic buttons (or similar emergency hardware) effective at the reception desk?

Is controlled access technology working effectively in the building lobby?

Is controlled technology working effectively at emergency fire exits?

Is secure technology operating effectively in the loading dock area?

Is the manufactured surveillance at the building entrance and lobby visible to users?

How complete is the coverage of the manufactured surveillance at the building entrance and lobby area?

Is there sufficient manufactured surveillance coverage at the reception desk?

### Wayfinding and Access Control

Are lobby programs and public circulation routes clearly visible from the primary lobby entrance?

Is there effective wayfinding signage within the entrance lobby?

Is there effective security signage within the entrance lobby?

Is there effective emergency assistance signage within the entrance lobby?

The responses to the questions are analyzed by the rating assignor module 132 and a rating is assigned to each of the physical elements.

During the exterior audit, illustrated in FIG. 6, elements relating to visibility 601, surveillance 602 and wayfinding and access control 603 for the exterior of the physical environment are considered. Sub-categories of visibility include obstructions 604, illumination 605 and line of sight 606. Sub-categories of surveillance include various forms of surveillance such as physical surveillance 607, natural surveillance 608 and manufactured or formal surveillance 609. Access and wayfinding can be broken down to movements and pathways 610 and physical access 611.

Areas considered during the exterior audit include loading docks, parking lots, and external gathering spaces. Attributes of physical elements from these areas are extracted and input to the deterrent rating assignor module 132 for assigning a deterrent rating to the physical elements.

An example of a questionnaire for the exterior audit is as follows:

### Example

### Visibilty

Does sufficient visibility exist when looking outwards from the site entrance?

Does the design of the site entrance encourage natural surveillance?

Does the design and layout of the external site furnishings encourage natural surveillance?

Is the lighting at the external site entrance at the appropriate level?

Is the lighting in naturalized landscaped areas at the appropriate level?

Does sufficient visibility exist when looking outwards from the external building entrance?

Are there opportunities for entrapment areas within 9 m of the external building entrance?

Does the building entrance massing and materiality encourage natural surveillance of the external building entrance?

Does the design and layout of the external site furnishings encourage natural surveillance?

Is the lighting at the external building entrance at the appropriate level?

During operational hours, is the lighting in the loading dock at the appropriate level?

During hours of closure, is the lighting in the loading dock at the appropriate level?

Is the lighting between 30-50LUX within the external site entrance?

Is the lighting between 30-50LUX within the loading docks and dock entries?

Is the lighting between 30-75LUX within building entries/exits?

Is the lighting between 55-100LUX within covered parking areas?

Is the lighting between 30-50LUX within uncovered parking areas?

### Surveillance

Is controlled access technology operating effectively at the building entrance?

Is controlled access technology operating effectively in the loading dock area?

Is the manufactured surveillance at the external building entrance visible to the users?

How complete is the coverage of the manufactured surveillance at the external building entrance?

Is manufactured surveillance in the loading dock area visible to the user?

How complete is the coverage of the manufactured surveillance at the loading dock area?

### Wayfinding and Access Control

Are there more public building entrances than are required by code or local bylaw?

How well defined is the public building entrance?

How well defined is the loading dock/service entrance?

Is the wayfinding, ownership and operational signage at the public building entrance effective?

Is the wayfinding and operational signage for the service entrance/loading dock effective?

Is the effective is vehicular signage at the external building entrance/vehicular drop-off area effective?

Is security signage clearly visible at the external building entrance?

Is there effective signage directing users to emergency assistance?

Are alternative transportation methods accessible from the building entrance?

Are taxi services accessible from the main building entrance?

Is access to the building entrance for emergency vehicles unimpeded?

The responses to the questions are analyzed by the deterrent rating assignor module 132 and a deterrent rating factor is assigned to each of the physical elements.

In one embodiment, each of the physical elements of the physical environment 1000 is given a weighting value based on the importance of the physical element and the rating factor assigned is based on the assigned weighting value and the extracted attributes of that physical element.

The deterrent ratings assigned to the physical elements during the interior and exterior audit are fed to the fourth risk calculator module 134 which in turn processes these deterrent ratings and generates a fourth risk score.

The first, second, third and fourth risk scores are then fed to a recommendation module 136 which analyzes these scores and generates a recommendation report or a protection or mitigation plan which when deployed secures the physical environment against crime. The physical environment when modified as per the recommendation report discourages a motivated offender from committing a crime within the physical environment.

Typically, the recommendation would include modification to one or more of the physical elements considered during the interior and exterior audit. Non-limiting examples of recommendations include placement of a CCTV at a different location, placement of a panic button at a different location or increasing the lumen of certain lighting structures.

In one embodiment, if the physical environment is new, the recommendation report contains recommendations for modifying a design plan such as a blueprint or architectural drawing of the physical environment.

In another embodiment, if the physical environment is pre-existing, the recommendation report contains recommendations for rehabilitation of at least one physical element associated with the physical environment.

Modification of the physical elements based on the recommendation report by the recommendation module 136 increases visibility or presence of an offender within the physical environment thereby deterring him from committing a crime within the physical environment.

A person skilled in the art will appreciate that the various modules described above may be implemented as a single module or as a plurality of modules that operate in cooperation with one another.

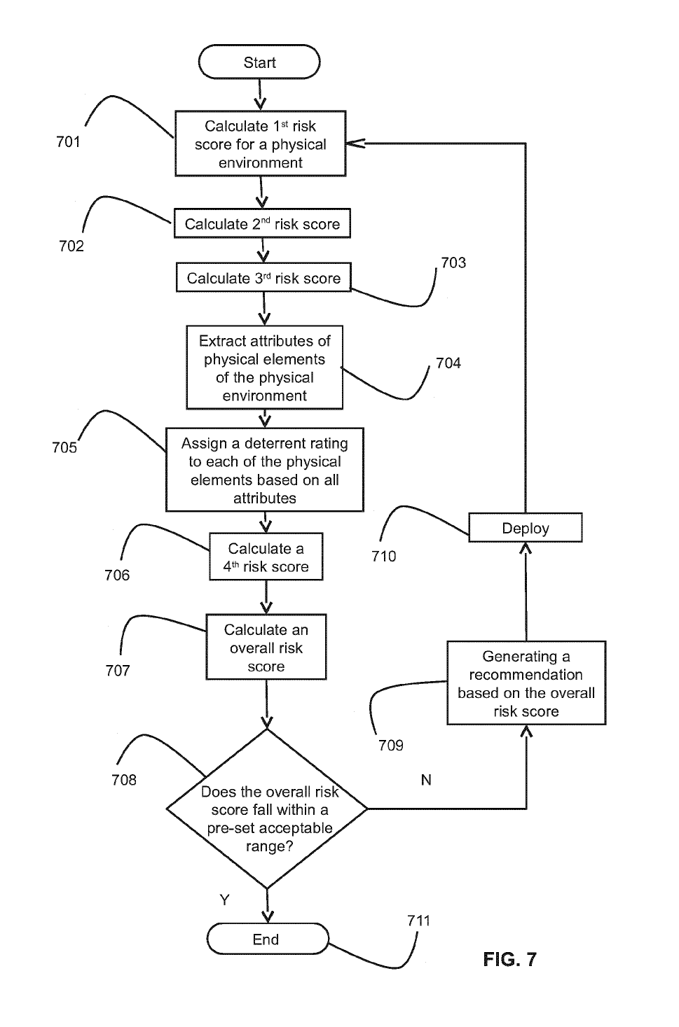

FIG. 7 is a flowchart illustrating, in detail, steps utilized in a method for securing a physical environment against crime according to one embodiment. The process begins at block 701 where a first risk score is calculated for the physical environment based on classification of the physical environment within a pre-determined category. At block 702, a second risk score is calculated for the physical environment based on the geographical location of the physical environment. At block 703, a third risk score is calculated based on review of management and security policies of the physical environment. At block 704, attributes of pre-determined physical elements contributing to the structural layout and working of the physical environment are extracted. At block 705, a deterrent rating factor to each of the pre-determined physical elements is assigned based on divergence or adherence of the extracted attributes to threshold attributes for the physical elements. At block 706, a fourth risk score is calculated based on the assigned deterrent rating factors. At block 707, an overall risk score for the physical environment is calculated based on the first risk score, the second risk score, the third risk score and the fourth risk score. In one embodiment, the overall risk score is an average of the first risk score, the second risk score, the third risk score and the fourth risk score. At block 708, the overall risk score is compared with a pre-determined threshold risk range. At block 709, if the overall risk score falls within the threshold risk range, the physical environment is considered safe and the process is terminated. If the score falls outside the threshold risk range, a recommendation report is generated for at least one of the physical elements. The physical elements when modified or changed or altered as per the recommendation report will secure the physical environment against crime.

In one embodiment, if the calculated overall score falls outside the threshold risk range, the deterrent ratings assigned to each of the physical elements are compared with respective pre-set deterrent threshold values set for each of the physical elements. For example, the threshold risk range can be anything below a certain pre-set deterrent threshold value, such as a minimum standard, and anything below that value is unacceptable and a recommendation report will result. In other embodiments, the threshold risk range can be anything above or below a certain pre-set deterrent threshold value, such as a case having too many points of ingress or too few points, and a recommendation report will result.

If the deterrent rating of a particular physical element is above or below the pre-set deterrent threshold value for that physical element, the recommendation module 136 obtains recommendations by accessing a recommendation table or dataset stored in a rule-based database 140 collaborating with the system 100. The table maps deterrent ratings to recommendations. Implementation of the recommendations improves the deterrent ratings and in turn makes the physical environment safe and secure.

In one embodiment, databases 138 and 140 may be implemented as a single database.

A person skilled in the art will understand that responses to the questions contained in the various databases referred to herein and displayed to a user on the interactive unit 106 will be associated with characteristics having a quantifiable state (characteristic data), at least some of the characteristics being associated with rules, the quantifiable state including logical values, yes/no values, and numerical values. The databases may also be associated with a security and authentication process enabling access based on compliance with pre-set access rights.

It will also be appreciated by those of skill in the art that the system 100 may provide assistance to a user to arrive at the correct quantifiable data or correct choice by leading a user through a smaller subset of related questions or by providing a definition for the quantifiable state.

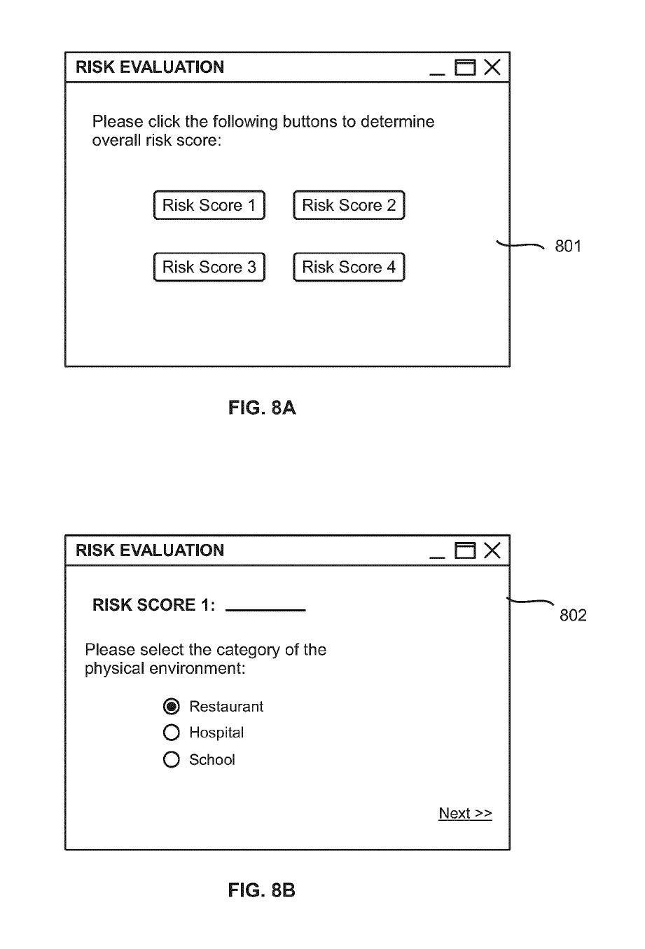

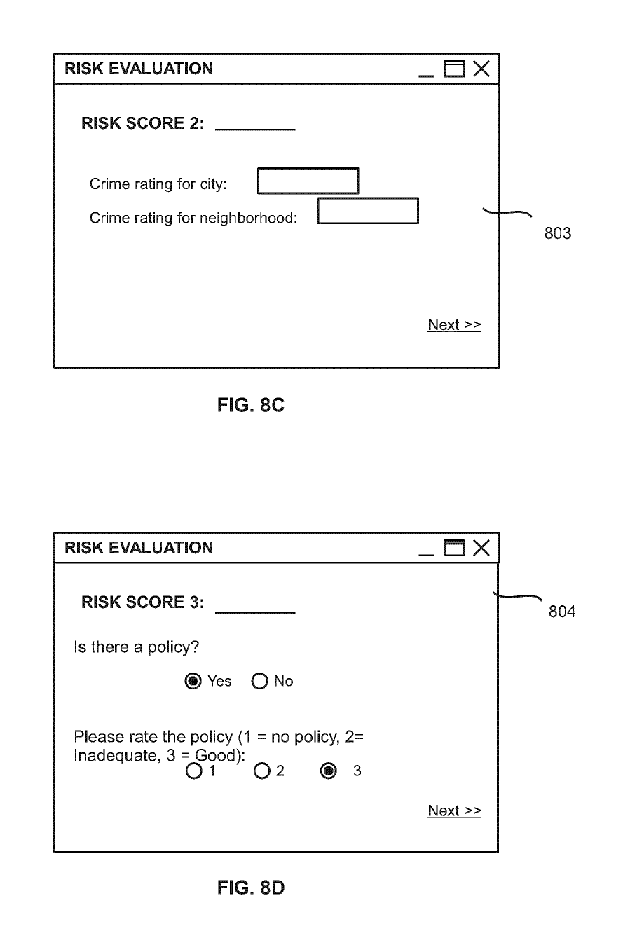

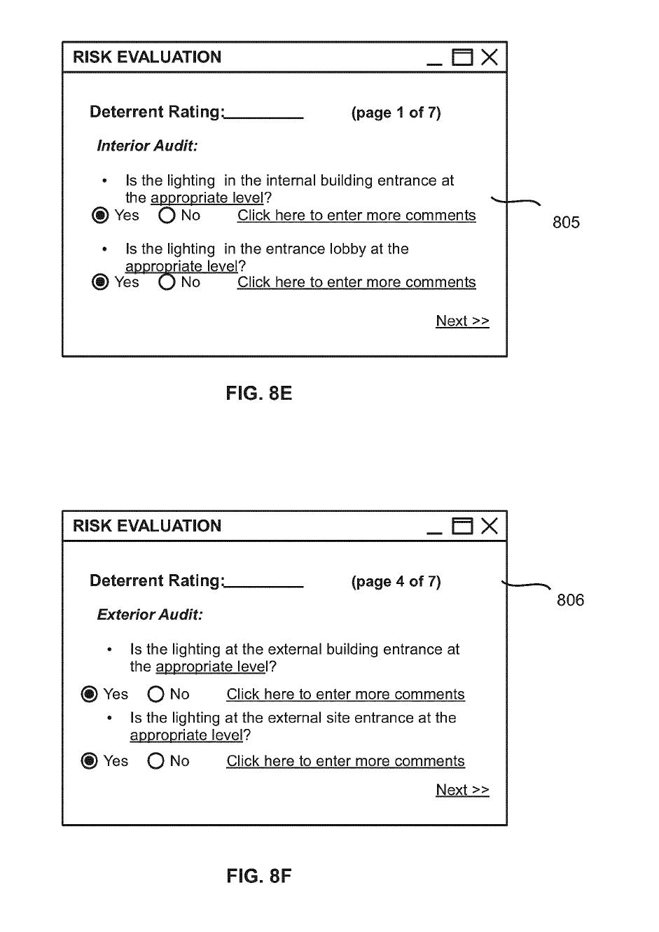

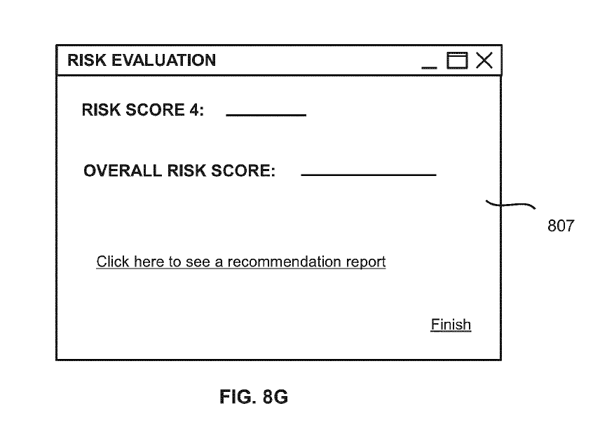

FIGS. 8A to 8F are screenshots of an exemplary embodiment of the interactive unit 106 provided by the system 100. The screen shots depict an example of an embodiment of system 100 as implemented on a tablet such as an iPad™ offered by Apple Inc. of Cupertino, Calif. Input is provided to such device via a touchscreen, including on-screen keyboard functionality. One skilled in the art will recognize that the screen shots depict an embodiment that is merely exemplary, and that the techniques described herein can be implemented on other devices using other layouts and arrangements.

When a user or assessor at the client computing device 106 launches a web browser and navigates to a website hosted by the system 100, the user is presented with a main web page/screen 801 illustrated in FIG. 8A. Activating one of the active fields labeled as Risk Score 1, Risk Score 2, Risk Score 3 and Risk Score 4 on the main web page 801 takes the user to a subsequent web page/screen associated with the active fields. FIG. 8B illustrates a webpage or screen associated with Risk Score 1. This screen prompts the user to select one of the options displayed on the screen. The options are related to identifying the nature of the physical environment. Risk Score 1 is based on the selection. FIG. 8C illustrates a webpage or screen 803 associated with Risk Score 2. This screen prompts the user to enter location identifiers of the physical environment namely city and neighborhood. Risk Score 2 is based on the responses to these questions. FIG. 8D illustrates a webpage or screen 804 associated with Risk Score 3. As explained earlier, Risk Score 3 is assigned on the basis of review of a management and a security of the physical environment. Accordingly, if there is no policy, option 1 is selected. If there is a policy, the user is directed to the policy and Risk Score 3 is assigned based on his evaluation of the review policy. In this example, the evaluation could result in options 2 or 3. As explained above, Risk Score 4 is calculated on the basis of an audit of the physical environment. Typically this involves an interior audit and exterior audit. FIG. 8E illustrates a webpage or screen 805 associated with the interior audit. As shown in FIG. 8E, the user is prompted to respond to a set of questions relating to physical elements of the physical environment. In this screen, the physical element is lighting. Based on the input received a deterrent rating is assigned to the physical element. Similarly, as shown in FIG. 8F, deterrent ratings are assigned to physical elements considered during the exterior audit. Screen 806 displays a subset of questions considered during the exterior audit. FIG. 8F illustrates a screen 807 which displays Risk Score 4 calculated based on the assigned deterrent ratings and an overall risk score calculated for the physical environment after the user has gone through the process steps identified in FIGS. 8A to 8E.

In one embodiment, the methodology described herein may be implemented as a standalone application on the client computing device 106 capable of communicating with one or more of the computer servers 104 for processing the method steps described herein.

The method described herein may be implemented as a rating system for the design, construction, operation, and maintenance of a physical environment. The rating system will be intended to help, owners and operators of a physical environment, to secure the physical environment against crime.

The following paragraphs describe a structured training program that systematically teaches personnel to conduct an audit of a physical environment and identify risks associated with the physical environment.

In one embodiment, the training program may be implemented as outlined below:

### SAFE™ Certified

### Course Outline: 4 Day Course (4 Day In-Person Course+Online Exam or 2 Day In-Person +2 Day On-line+Online Exam)

This course will target individuals who do not plan on practicing as an assessor or at a higher level but are wishing to be educated in SAFE Design Standard.

### SAFE™ Certified Assessor

### Course Outline: 4 Day Course (4 Day In-Person Course+Online Exam or 2 Day In-Person+2 Day Online+Online Exam)

This course will target individuals who wish to pursue a career as a SAFE™ Certified Assessor. Examples of such a target group may be realty appraisers, property managers, facilities management, university students, criminal justice professionals, police and security professionals and insurance appraisers. Individuals with a recent CPTED certification need to attend only the 2 Day In-Person and must pass the Online Exam.

### SAFE™ Certified Designers

### Course Outline: 3 Day Course (2 Day In-Person Course+1 Day Online Prep+Online Exam)

This course is designed for professionals in the field of building and maintaining physical environments. Examples of such a target group are architects, landscape architects, engineers, designers and city planners.

### SAFE™ Certified Auditors

### Course Outline: 3 Day Course (2 Day In-Person Course+1 Day Online Prep+Online Exam)

This course is designed for professionals in the field of maintaining physical environments, for example, auditors and consultants.

### SAFE™ Certified Specialists

Pre-requisites: Assessor & Auditors Training+Minimum of 1,000 hours of experience to be eligible for this course.

### Course Outline: 3 Day Course In-Person (2 Day In-Person Training and Seminar & 1 Day Online Class+Online Exam)

This course is designed for the highest level of certification for assessors and auditors to conduct assessments in ‘high risk’ or complicated locations such as borders, airports and police agency buildings.

### SAFE™ Certified Trainers

Pre-requisites: Requires all levels of training+Minimum of 1,000 hours of experience to take this course.
Course Outline: 5 Day Course In-Person (5 Day In-Person Course & 2 Days Online Class+In person Exam)
This course is designed for the highest level of certification for training assessors, auditors, designers and specialists.

In one embodiment, the system may further comprise a training module (not shown) for training and certifying a personnel to perform an audit of a physical environment to secure it against crime is provided. The method comprises defining a prerequisite skill set matrix. Non-limiting examples of a skill set include four years of experience as an architect or recent CPTED certification. The personnel's knowledge or skill set is matched or compared with the prerequisite skill set matrix. Comparison determines eligibility of the personnel to interact with one or more training modules. The training modules contain information or scenarios relating to conducting an audit of a physical environment so as to identify risks associated therewith. The training modules also contain information relating to generating a mitigation plan which when deployed negates or mitigates the identified risks. The method further comprises imparting at least one scenario exercise based on the content of the one or more exercise modules and testing the personnel's interaction with the at least one scenario exercise. A test result is then generated based on the personnel's interaction with the at least one scenario exercise. The test result is compared with an acceptable standard to determine eligibility and suitability of the personnel to be certified.

1. A computer-implemented method of analysing and designing a physical environment for discouraging criminal activity within the physical environment, the method comprising:
calculating a first risk score based on classification of the physical environment within a pre-determined category;
calculating a second risk score based on the geographical location of the physical environment;
calculating a third risk score based on review of management and security policies of the physical environment;
calculating a fourth risk score by
extracting from the physical environment's three dimensional data, attributes of pre-determined physical elements which contribute to the structural layout and working of the physical environment;
assigning a deterrent rating to each of the physical elements based on divergence or adherence of the extracted attributes to threshold attributes for the physical elements; and
calculating the fourth risk score based on the assigned deterrent ratings; and
generating a recommendation report for at least one of the physical elements for improving the deterrent rating assigned thereto, the recommendation report being generated based on the first risk score, the second risk score, the third risk score and the fourth risk score.

2. The method of claim 1, wherein improvement of the deterrent rating comprises improving detectability of a motivated offender within the physical environment thereby discouraging the motivated offender from committing the crime activity within the physical environment.

3. The method of claim 1 further comprising:
calculating an overall risk score based on the first risk score, the second risk score, the third risk score and the fourth risk score;
comparing the overall risk score with a pre-determined threshold risk range; and
generating the recommendation report if the overall score is outside the pre-determined threshold risk range.

4. The method of claim 3 wherein if the overall risk score is outside the pre-determined threshold risk range, the method further comprising:
comparing the assigned deterrent ratings with pre-set deterrent threshold values; and
generating the recommendation report if the assigned deterrent ratings are below the pre-set deterrent threshold values.

5. The method of claim 1, wherein the step of classifying the physical environment within a pre-determined category is carried out on the basis of data received regarding the function of the physical environment.

6. The method of claim 1, wherein the step of assigning a second risk score further comprises:
retrieving historical crime data linked to the geographical location of the physical environment from a database, and
surveying the physical environment and geographical location for collaborating indicators contributing to the retrieved historical crime data.

7. The method of claim 6, wherein the collaborating indicators contributing to the retrieved crime data comprises at least one of graffiti writing, broken windows and unmaintained roads.

8. The method of claim 6, wherein the database is maintained by a national, federal, provincial or municipal policing body.

9. The method of claim 1, wherein the step of assigning the deterrent rating to each of the physical elements comprises displaying a set of questions regarding the attributes of the physical element.

10. The method of claim 9 further comprising selecting an appropriate set of questions for display based on fit of the physical environment within the pre-determined category.

11. The method of claim 1, wherein the pre-determined physical elements comprise elements governing at least one entry and at least one exit to the physical environment, vehicular and/or human traffic about and within the physical environment, landscaping surrounding the physical environment, illumination profile about and within the physical environment, and signage about and within the physical environment.

12. The method of claim 1, wherein the physical environment is a pre-existing environment or a new physical environment.

13. The method of claim 12, wherein if the physical environment is new, the recommendation report contains recommendations for modifying a design plan of the physical environment.

14. The method of claim 12, wherein if the physical environment is pre-existing, the recommendation report contains recommendations for rehabilitation of at least one physical element associated with the physical environment.

15. The method of claim 1, wherein the step of extracting attributes comprises review of a design plan of the physical environment or survey of the physical environment by personnel.

16. A computer based system for analysing and designing a physical environment for deterring a motivated offender from committing a crime within the physical environment, the system comprising:
a memory;
a processing structure coupled to the memory and executing computer-readable code for calculating a first risk score based on classification of the physical environment within a pre-determined category;
calculating a second risk score based on the geographical location of the physical environment;
calculating a third risk score based on review of management and security policies of the physical environment;
calculating a fourth risk score based on a deterrent rating assigned to at least one physical element of the physical environment; and
generating a recommendation report for the at least one physical element for improving the deterrent rating assigned thereto, the recommendation report being generated based on the first risk score, the second risk score, the third risk score and the fourth risk score.

17. The system of claim 16, wherein the deterrent rating assigned to the at least one physical element comprises extracting attributes of the at least one physical element by receiving input to a set of questions regarding the attributes and comparing the extracted attributes with pre-set threshold attribute values for the at least one physical element.

18. The system of claim 16 further comprising at least one database for storing the set of questions and at least one interactive unit to display the set of questions.

19. A non-transitory computer-readable storage medium comprising computer-executable instructions for analysing and designing a physical environment for deterring a motivated offender from committing a crime within the physical environment, the instructions, when executed, cause a processor to perform process steps comprising:
calculating a first risk score based on classification of the physical environment within a pre-determined category;
calculating a second risk score based on the geographical location of the physical environment;
calculating a third risk score based on review of management and security policies of the physical environment;
calculating a fourth risk score based on a deterrent rating assigned to at least one physical element of the physical environment; and
generating a recommendation report for the at least one physical element for improving the deterrent rating assigned thereto, the recommendation report being generated based on the first risk score, the second risk score, the third risk score and the fourth risk score.
